(19) United States
(12) Patent Application Publication
(10) Pub. No.: US 2026/0296651 A1
(43) Pub. Date: Oct. 1, 2026

(54) SYSTEM FOR DE-ICING A SURFACE OF AN AIRCRAFT

(71) Applicant: SAFRAN AEROSYSTEMS, Plaisir (FR)

(72) Inventors: Loic BOISSY, Moissy-Cramayel (FR); Francois CAPORAL, Moissy-Cramayel (FR); Antoine FREMONT, Moissy-Cramayel (FR); Franck RENAUD, Moissy-Cramayel (FR)

(21) Appl. No.: 19/489,827

(22) PCT Filed: Jun. 4, 2024
(86) PCT No.: PCT/FR2024/050715

§ 371 Date: Dec. 3, 2025

(30) Foreign Application Priority Data
Jun. 5, 2023 (FR) FR2305637

(51) Int. Cl. B64D 15/06; B64D 15/20

(52) U.S. Cl. CPC B64D 15/06; B64D 15/20

(57) ABSTRACT

A de-icing system capable of de-icing a surface of an aircraft, the system comprising including a fluid circuit that includes at least: a pressurized tank; at least one pneumatic de-icing device, at least one first switch; at least one second switch; and a pressurized fluid distribution device configured to bring about: the delivery of a pressurized fluid to the pneumatic de-icing device via the pressurized tank and the first switch and/or o the removal of the pressurized fluid from the pneumatic de-icing device via the first switch and the second switch.

### TECHNICAL FIELD

The invention relates to the field of managing the condition of a surface of an aircraft. It relates in particular to a de-icing system for a surface of an aircraft and a method of using such a de-icing system.

### PRIOR ART

The state of the art comprises the documents WO-A1-2015110974, GB-A-2355243, US-A1-3720388 and CA-A1-3073456.

To remove the ice that may be present on the surface of an aircraft, it is common practice to use de-icing devices, the function of which is based on the use of a pressurized fluid, for example, air under pressure, otherwise known as pressurized air.

Such de-icing devices must be supplied with air under pressure in order to be able to de-ice, often by mechanical action, a surface of an aircraft on which they are installed.

In the prior art, the pressurized air used to supply the de-icing devices is taken from an engine of the aircraft, for example from an air flow circulating in a turbomachine. This is referred to as engine air bleed.

However, there are a number of disadvantages to this approach. In fact, the engine air bleed has an effect on the aircraft's engine speed and therefore on its performance. In addition, the pressurized air sampled has higher pressure and temperature values than those strictly necessary for the operation of the de-icing devices. In addition, the energy consumption associated with powering the de-icing devices is also higher than necessary, which may require sizing specifically adapted to the needs of the de-icing devices.

Lastly, such de-icing devices must be maintained in a vacuum when no de-icing is required, which means that air is constantly being consumed and energy is being lost.

### SUMMARY OF THE INVENTION

The present invention proposes a solution to these disadvantages.

The aim of the invention is to provide a de-icing system that does not require the use of engine air bleed while exhibiting optimized efficiency.

To this end, the object of the invention according to a first aspect is a de-icing system, capable of de-icing a surface of an aircraft, comprising a fluid circuit comprising at least:
a pressurized tank;
at least one pneumatic de-icing device;
at least one first switching means; and
at least one second switching means.

More particularly, the fluid circuit comprises at least one pressurized fluid distribution device configured to bring about:
a delivery of a pressurized fluid to the pneumatic de-icing device via the pressurized tank and the first switching means, and/or
the removal of pressurized fluid from the pneumatic de-icing device, via the first switching means and the second switching means.

Furthermore, the pressurized fluid distribution device may be configured to cause the pneumatic de-icing device to be vacuumed, via the first switching means and the second switching means.

The de-icing system according to the invention can comprise a control unit configured to control pressurization of the pressurized tank, inflation, deflation and/or vacuuming of the pneumatic de-icing device.

The de-icing system according to the invention may have one or more of the following characteristics, taken alone or in combination with each other, whereby the de-icing system may comprise:
a compressor, in particular an electric compressor, as a pressurized fluid distribution device;
at least a sensor capable of measuring a pressure of the pressurized fluid in the pneumatic de-icing device;
a non-return valve, in particular a heated one, arranged in the fluid circuit at the outlet of the pressurized fluid distribution device;
at least one drainage means, in particular a drainage valve;
a pressure limiter arranged in the fluid circuit at an outlet from the pressurized tank; and/or
the second switching means comprises a port configured to allow an external fluid to be injected into the fluid circuit, in particular the pressurized air from a cabin of the aircraft.

The invention according to a second aspect also relates to a method of using at least one system for de-icing a surface of an aircraft, in particular according to the first aspect, comprising at least:
a filling step, during which a pressurized tank is filled with pressurized fluid;
an inflation step, during which at least one pneumatic de-icing device is inflated from the pressurized fluid contained in the pressurized tank; and
a deflation step, during which the pneumatic de-icing device is deflated.

In addition, the method of use according to the invention may comprise at least:
a vacuum step, during which the pneumatic de-icing device is subjected to a vacuum ; and/or
a filling step, during which the pressurized tank is filled with the pressurized fluid from the pneumatic de-icing devices;

Furthermore, according to the method of use according to the invention, the inflation step and the deflation step can be repeated successively.

Finally, according to various additional characteristics, the method of use according to the invention may comprise one or more of the following characteristics, taken alone or in combination with one another, according to which:
the filling step may comprise at least one of the following sub-steps consisting of:
   a pressure measurement step, during which a pressure sensor measures a pressure in the pressurized tank;
   a step of activating the distribution device, during which the pressurized fluid distribution device is put into operation, so as to supply the pressurized tank with pressurized fluid;
   a configuration step in “filling” mode, during which:
      an output of a first switching means connected to a second switching means is open;
      an inlet of the first switching means connected to the pressurized tank, in particular via a pressure limiter, is closed; and
      an outlet of the second switching means connected to the pressurized tank is opened:
the inflation step may comprise at least the following sub-step consisting of:
   an “inflation” mode configuration step, during which:
      the second switching means is closed;
      an output of the first switching means connected to the second switching means is closed; and
      an output of the first switching means connected to the pneumatic de-icing device is opened.
the deflation step may comprise at least one of the following sub-steps consisting of
   a distribution device activation step, during which the pressurized fluid distribution device is put into operation, so as to deflate and/or vacuum the pneumatic de-icing device;
   a “deflation” mode configuration step, during which:
      an inlet of the first switching means connected to the pressurized tank, in particular via the pressure limiter, is closed; and
      an output of the first switching means connected to the second switching means is open.

### BRIEF DESCRIPTION OF THE FIGURES

The invention will be better understood and other features and advantages will become apparent from the detailed description which follows, comprising embodiments given solely by way of non-limiting example with reference to the appended figures, which may serve to complete the understanding of the invention and the description of its embodiment and, where appropriate, contribute to its definition, on which:

FIG. 1 is a schematic representation of a de-icing system according to the invention; and,

FIG. 2 is an implementation diagram for a method of using a de-icing system according to the invention.

### DESCRIPTION OF THE EMBODIMENTS

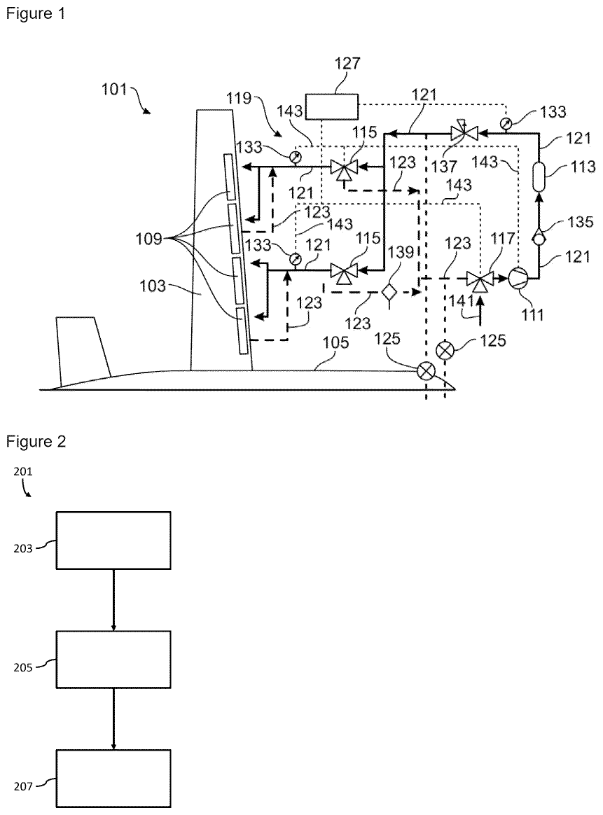

FIG. 1 is a schematic representation of an embodiment of a de-icing system 101 according to the invention. Such a de-icing system 101 is configured to ensure the de-icing of a surface 103 of an aircraft 105.

In the non-limiting example described with reference to FIG. 1, the aircraft 105 is equipped with a plurality of de-icing systems 101. For the sake of clarity, only one de-icing system 101 is shown in FIG. 1.

As shown, the de-icing system 101 is assigned to de-icing the surface 103, in particular a wing of the aircraft 105.

In general, the invention allows, by means of a de-icing system 101 or a plurality of de-icing systems 101 to remove the ice from one or more areas of the surface 103 of the aircraft 105.

In addition, according to the invention, the various de-icing systems 101 may be independent of one another and/or linked together by at least one fluid connection, possibly via at least one valve.

According to the present invention, the de-icing system 101 comprises at least one pneumatic de-icing device 109. In the example shown in FIG. 1, the de-icing system 101 comprises four pneumatic de-icing devices 109.

A pneumatic de-icing device of this type can be, by way of a non-limitative example, a device as described in European patent application EP-A1-3097017, known in particular as a “pneumo-expulse”.

More generally, the pneumatic de-icing device 109 according to the invention can inflate, deflate and/or be vacuumed, depending on whether or not it is supplied with a pressurized fluid.

The inflation of the pneumatic de-icing device 109 causes the de-icing of the surface 103 of the aircraft 105 at which the pneumatic de-icing device 109 is positioned.

In addition, the de-icing system 101 also comprises a pressurized fluid distribution device 111, such as a compressor 111, configured to bring out
a delivery of a pressurized fluid to the pneumatic de-icing device 109, ensuring the inflation of the pneumatic de-icing device 109, and/or
the pressurized fluid is withdrawn from the pneumatic de-icing device 109, ensuring the deflation of the pneumatic de-icing device 109.

According to the invention, the deflation of the pneumatic de-icing device can be complete in that the pneumatic de-icing device 109 is subjected to a vacuum by the action of the pressurized fluid distribution device 111.

In a particular embodiment, the pressurized fluid distribution device 111 is an electric compressor.

In the non-limiting example shown, in addition to the elements already described, the de-icing system 101 comprises in particular
a pressurized tank 113,
at least one first switching means 115, in particular a first valve 115, in particular a first “three-way” valve 115 and
at least one second switching means 117, in particular a second valve 117, in particular a second “three-way” valve 117.

The pressurized tank 113 is supplied with pressurized fluid, in particular pressurized air, by the pressurized fluid distribution device 111. The pressurized tank 113 is suitable for:
storing the pressurized fluid,
releasing the pressurized fluid to the pneumatic de-icing device 109 via at least one fluid connection.

The first switching means 115, respectively the second switching means 117, are capable of allowing a flow of the pressurized fluid from at least one first port of the switching means to at least one second port of the switching means in all the configurations made possible by the first switching means 115, respectively the second switching means 117.

The elements of the de-icing system 101, i.e. in particular the pressurized fluid distribution device 111, the pressurized tank 113, the first switching means 115, the second switching means 117 and the pneumatic de-icing device 109, are integrated in a fluid circuit 119.

To this end, the fluid circuit 119 comprises at least one fluidic connection, such as pressurized fluid circulation ducts, between the elements of the de-icing system 101 so that pressurized fluid can circulate from one element of the de-icing system 101 to another element of the de-icing system 101.

In particular, the fluid circuit 119 is such that the pressurized fluid distribution device 111 is able to bring about:
delivering the pressurized fluid to the pneumatic de-icing device 109, via the pressurized tank 113 and the first switching means 115, and/or
removing the pressurized fluid and/or vacuuming of the pneumatic de-icing device 109, by means of the first switching means 115 and the second switching means 117.

Thus, the fluid circuit 119 comprises:
a supply line, symbolized by solid arrows 121 in FIG. 1, from the pressurized fluid distribution device 111 to the pneumatic de-icing device 109, in order to supply the pneumatic de-icing device 109 with pressurized fluid, and
a removal line, symbolized by dotted arrows 123 in FIG. 1, running from the pneumatic de-icing device 109 to the pressurized fluid distribution device 111, in order to remove the pressurized fluid and/or vacuum the pneumatic de-icing device 109.

In particular, for a portion of the fluid circuit 119 between the pneumatic de-icing device 109 and the first switching means 115, the supply line and the removal line may be constituted by one and the same fluidic connection.

Thus configured, the fluid circuit 119 is such that:
the supply line constitutes a downstream part of the fluid circuit 119 between the pressurized fluid distribution device 111 and the pneumatic de-icing device 109 in the direction of flow of the pressurized fluid, and
the withdrawal line constitutes an upstream part of the fluid circuit 119 between the pneumatic de-icing device 109 and the pressurized fluid distribution device 111, according to the direction of flow of the pressurized fluid.

Alternatively, the fluid circuit 119 is configured so that the feed line and the removal line are separate. Thus,
a first fluid connection links the first switching means 115 to the pneumatic de-icing device 109, in order to supply the pneumatic de-icing device 109 with pressurized fluid; and
a first fluid connection links the pneumatic de-icing device 109 to the first switching means 115 at the pneumatic de-icing device 109, in order to remove the pressurized fluid and/or vacuum the pneumatic de-icing device 109.

More precisely, according to the embodiment shown, the fluid circuit 119 is configured so that:
the pneumatic de-icing device 109 has a fluidic connection with the first switching means at 115,
the first switching means 115 has a fluid connection with,
   on the one hand, the second switching means 117 and
   on the other hand, the pressurized tank 113, and
The pressurized fluid distribution device 111 has a fluid connection with,
   on the one hand, the second switching means 117 and,
   on the other hand, the pressurized tank 113.

In addition, in the non-limiting example shown in FIG. 1, the de-icing system 101 comprises a control unit 127. The control unit 127 is able to control the operation of the de-icing system 101 as a whole, in particular by controlling all or some of the elements of the de-icing system 101, as shown in thin dashed lines 143 in FIG. 1.

In particular, the control unit 127 implements control laws for the de-icing system 101 which result in the pressurization of the pressurized tank 113, inflation, deflation, and/or vacuuming the pneumatic de-icing device 109.

The control laws can be implemented via dedicated logic for each of the actions of pressurizing the pressurized tank 113, inflation, deflation and/or vacuuming of the pneumatic de-icing device 109, for example by means of specific electronic circuits, in particular included in an electronic box.

In another embodiment, the control laws can be integrated into a remote control system, for example an avionics system of the aircraft 105.

The control unit 127 can also monitor the correct operation of the de-icing system 101. Such monitoring can be carried out by managing the signals from at least one sensor 133 and providing feedback, particularly in the event of faults in the aircraft 105.

In the non-limiting example shown in FIG. 1, the de-icing system 101 comprises two first switching means 115 respectively connected to two pneumatic de-icing devices 109.

The invention applies more generally to a de-icing system 101 which comprises at least one first switching means 115 having a fluid connection with at least one pneumatic de-icing device 109.

As previously mentioned, in the example shown in FIG. 1, several de-icing systems 101 can be fluidically connected via at least one isolation valve 125, which can be controlled by the control unit 127. In this way, pressurized fluid can circulate between at least two de-icing systems 101 when the isolation valve 125 is open. In particular, the de-icing system 101 can support another de-icing system 101 when it fails.

In addition, the pressurized fluid distribution device 111 of a first de-icing system 101 can act as an emergency pressurized fluid distribution device 111 of a second de-icing system 101 and, thus, supply pressurized fluid and/or deflate pneumatic de-icing devices 109 of the second de-icing system 101 and/or to vacuum pneumatic de-icing devices 109 of the second de-icing system 101, in the event of failure of the pressurized fluid distribution device 111 of the second de-icing system 101.

In the non-limiting example shown in FIG. 1, the de-icing system 101 may also comprise at least one sensor 133, in particular a pressure sensor 133, at least one non-return valve 135 and/or at least one pressure limiter 137.

In particular, the sensor 133 is a pressure sensor configured to measure a pressure of the pressurized fluid at the pneumatic de-icing device 109. In the non-limiting example shown, the sensor 133 may be associated with a pair of pneumatic de-icing devices 109 to measure a value of the pressure at the pneumatic de-icing devices 109.

However, in various embodiments of the invention, the de-icing system 101 comprises at least one sensor 133. The number of sensors 133 and their arrangement may be adapted to the number of pneumatic de-icing devices 109 used and/or to the need to control the operation of the de-icing system 101.

Advantageously, the sensor 133 allows, for example, to transmit information to control unit 127 controlling the de-icing system 101, a pressure value at the pneumatic de-icing device 109 and, consequently, to adjust, if necessary, the control of the elements of the de-icing system 101, in particular by controlling and/or controlling the pressurized fluid distribution device 111.

In addition, the sensor 133 can also be used to detect pressure faults in the pressurized fluid in the fluid circuit 119.

In addition, such a sensor 133 can be positioned at another location in the fluid circuit 119, such as at the outlet of the pressurized fluid distribution device 111 and/or at the outlet of the pressurized tank 113 to enable the pressure level in the de-icing system 101 to be monitored and, if necessary, adjusted.

The non-return valve 135 can be arranged, in the fluid circuit 119, at the outlet of the pressurized fluid distribution device 111, i.e. between the pressurized fluid distribution device 111 and the pressurized tank 113. The non-return valve 135 blocks any backflow of pressurized fluid towards the pressurized fluid distribution device 111, which could damage it.

In addition, as with the first switching means 115, the second switching means 117 and/or the isolation valve 125 integrated into the de-icing system 101, as equipment intended for use in the aircraft 105 and potentially subjected to low temperatures or even sub-zero temperatures, the non-return valve 135 can be heated (for example via integrated or non-integrated heating means) to prevent possible malfunction.

Similarly, for similar reasons, the first switching means 115, the second switching means 117 and/or the isolation valve 125 can be heated to prevent any malfunction.

The pressure limiter 137 can also be arranged in the fluid circuit 119 at the outlet of the pressurized tank 113. Thus, when the pressurized tank 113 is full, and/or when the pressurized tank 113 has reached a nominal pressure value, i.e. a pressure value intended for the operation of the de-icing system 101, the pressure limiter 137 is able to allow the discharge of any additional pressurized fluid potentially delivered by the pressurized fluid distribution device 111. The pressure limiter 137 thus allows the pressure in the pressurized tank 113 to be maintained at the nominal pressure value.

Typically, when no de-icing is required, the pressurized fluid distribution device 111 can nevertheless be activated to regulate the vacuum level in the pneumatic de-icing device 109, for example following a measurement made by the sensor 133. In such a case, if the pressurized tank 113 has already reached the nominal pressure, the pressure limiter 137 may allow the fluid from the pressurized fluid distribution device 111 to be discharged.

In addition, the de-icing system 101 may also comprise at least one drainage means 139, in particular a drainage valve 139, to allow any condensed water present in the de-icing system 101 to be drained off.

FIG. 2 is an implementation diagram for a method of use 201 of the de-icing system 101 as described with reference to FIG. 1.

The method of use 201 comprises at least one filling step 203, during which the pressurized tank 113 is filled, consisting of pressurizing the pressurized tank 113 with a pressurized fluid, in particular pressurized air.

The method of use 201 may also comprise a vacuuming step, during which at least one pneumatic de-icing device 109 is subjected to a vacuum. The vacuum step can be carried out after, before or simultaneously with the filling step 203.

The filling step 203 may comprise a “filling” mode configuration step, during which:
an output of the first switching means 115 connected to the second switching means 117 is open;
an inlet of the first switching means 115 connected to the pressurized tank 113, in particular via the pressure limiter 137, is closed; and
an output of the second switching means 117 connected to the pressurized tank 113 is opened.

In addition, the filling step 203 may comprise at least one of the following sub-steps consisting of:
a pressure measurement step, during which the sensor 133 measures the pressure in the pressurized tank 113; and/or
a step of activating the distribution device, during which the pressurized fluid distribution device 111 is put into operation, so as to supply the pressurized tank 113 with pressurized fluid.

More particularly, the activation step of the distribution device provides for an activation of the pressurized fluid distribution device 111 as long as the pressure measured in the pressurized tank 113 is less than the nominal pressure.

In addition, optionally, the filling step 203 may comprise, in particular during the “filling” mode configuration step, an opening step, during which an inlet of the second switching means 117 connected with the outside of the fluid circuit 119 may be opened to reach the nominal pressure in the pressurized tank 113.

The method of use 201 also comprises at least one inflation step 205, during which inflation, i.e. a supply of pressurized fluid, of the pneumatic de-icing device 109 is provided from the pressurized fluid contained in the pressurized tank 113.

The inflation step 205 may comprise a configuration step in “inflation” mode, during which:
the second switching means 117 is closed;
an output of the first switching means 115 connected to the second switching means 117 is closed; and
an output of the first switching means 115 connected to the pneumatic de-icing devices 109 is open.

In addition, the inflation step 205 may provide for opening of the output of the first switching means 115 connected to the pneumatic de-icing device 109 for a specified time, so as to ensure inflation of the pneumatic de-icing device 109 to the nominal pressure. Consequently, when the nominal pressure of the pneumatic de-icing device 109 is reached, the inflation step 205 may provide for closure of the output of the first switching means 115 connected to the pneumatic de-icing devices 109.

The method of use 201 further comprises at least one deflation step 207, during which the pneumatic de-icing device 109 is deflated and/or vacuumed.

The deflation step 207 may comprise a filling step, during which the pressurized tank 113 is filled with the pressurized fluid from the pneumatic de-icing device 109.

The deflation step 207 may comprise at least one step consisting of an activation step of the distribution device, during which the pressurized fluid distribution device 111 is put into operation, so as to deflate and/or vacuum the pneumatic de-icing device 109.

In addition, the deflation step 207 may comprise a “deflation” mode configuration step, during which:
an inlet of the first switching means 115 connected to the pressurized tank 113, in particular via the pressure limiter 137, is closed; and,
an output of the first switching means 115 connected to the second switching means 117 is open.

In addition, the deflation step 207 may provide for the opening of the output of the first switching means 115 connected to the second switching means 117 for a predetermined period of time, so as to ensure deflation and/or vacuuming of the pneumatic de-icing device 109.

In practice, the inflation step 205 and the deflation step 207 may be performed iteratively and/or repetitively until complete de-icing of the relevant surface 103 of the aircraft 105 is achieved.

In addition, when the de-icing system 101 comprises several pneumatic de-icing devices 109 respectively dedicated to different parts of the surface 103 of the aircraft 105, the method of use 201 may provide for simultaneous, successive, alternative or combined activation of the pneumatic de-icing devices 109, the first switching means 115 and/or the second switching means 117.

It is thus possible to define at least one de-icing cycle, covering all or part of the surface 103 of the aircraft 105, by dedicated activation of all or part of the pneumatic de-icing devices 109, the first switching means 115 and/or the second switching means 117, during which the inflation step 205 and the deflation step 207 are repeated successively.

Such a de-icing cycle can be repeated until the entire surface 103 covered by a de-icing system 101 has been treated.

Advantageously, thanks to the arrangement of the various elements of the de-icing system 101 in a single fluid circuit 119, the pressurized fluid used by the pneumatic de-icing device 109 is drawn in again when the pneumatic de-icing devices 109 are deflated and/or vacuumed, to be stored in the pressurized tank 113.

The de-icing system 101 therefore recycles the fluid so that no energy is wasted recompressing fluid newly injected into the de-icing system 101.

In addition, the second switching means 117 may comprise a port configured to allow the injection of external fluid, i.e. external to the fluid circuit 119, into the fluid circuit 119.

Thus, in the embodiment shown, pressurized fluid from another system, for example pressurized air from an aircraft cabin 105, symbolized by an arrow 141 in FIG. 1, is injected into the fluid circuit 119 at the second switching means 117.

The external fluid injected into the fluid circuit 119 then circulates in the fluid circuit 119 and helps to fill the pressurized tank 113 under the effect of the pressurized fluid distribution device 111.

Advantageously, injecting air from the cabin of the aircraft 105 allows air at a certain pressure value to be used directly and limits or even eliminates the energy required, i.e. consumed by the pressurized fluid distribution device 111, to pressurize the injected air.

In conclusion, in addition to the absence of engine bleed air resulting from the recycling of the air used by the de-icing system 101, the de-icing system 101 according to the invention also allows an electricity consumption to be reduced thanks to the recycling of the pressurized fluid operated.

In addition, the combination of several de-icing systems 101 in an assembly allows for a modular assembly that meets a multi-zone de-icing requirement while guaranteeing, through redundancy of the de-icing systems 101, a level of safety required for use in an aircraft.

Of course, the invention is not limited to the above-described embodiments, which are provided by way of example only. It encompasses various modifications, alternative forms and other variants that may be envisaged by the person skilled in the art in the context of the present invention, and in particular any combination of the various modes of operation described above, which may be taken separately or in combination.

1. A de-icing system capable of de-icing a surface of an aircraft, comprising a fluid circuit that comprises at least:
a pressurized tank,
at least one pneumatic de-icing device,
at least one first switching means, and
at least one second switching means,
wherein the fluid circuit comprises at least one pressurized fluid distribution device configured to bring about:
a delivery of pressurized fluid to the pneumatic de-icing device, via the pressurized tank and the first switching means, and/or
the removal of the pressurized fluid from the pneumatic de-icing device, via the first switching means and the second switching means.

2. The de-icing system according to claim 1, wherein the pressurized fluid distribution device is configured to cause the pneumatic de-icing device to be vacuumed via the first switching means and the second switching means.

3. The de-icing system according to claim 1, wherein the system comprises a control unit configured to control pressurization of the pressurized tank, inflation, deflation and/or vacuuming of the pneumatic de-icing device.

4. The de-icing system according to claim 1, wherein the pressurized fluid distribution device is a compressor, in particular an electric compressor.

5. The de-icing system according to claim 1, wherein the system comprises at least a sensor, capable of measuring a pressure of the pressurized fluid, at the level of the pneumatic de-icing device.

6. The de-icing system according to claim 1, wherein the system comprises a non-return valve, in particular a heated one, arranged in the fluid circuit at the outlet of the pressurized fluid distribution device.

7. The de-icing system according to claim 1, wherein the system comprises at least one drainage means, in particular a drainage valve.

8. The de-icing system according to claim 1, wherein the system comprises a pressure limiter arranged, in the fluid circuit, at an outlet from the pressurized tank.

9. The de-icing system according to claim 1, wherein the second switching means comprises a port configured to allow an external fluid to be injected into the fluid circuit, in particular pressurized air from a cabin of the aircraft.

10. A method of using at least one system for de-icing a surface of an aircraft, according to claim 1, wherein the method comprises at least:
a filling step, during which a pressurized tank is filled with pressurized fluid; an inflation step during which at least one pneumatic de-icing device is inflated from the pressurized fluid contained in the pressurized tank; and
a deflation step, during which the pneumatic de-icing device is deflated.

11. The method of use according to claim 10, wherein the method comprises at least one vacuum step, during which the pneumatic de-icing device is subjected to a vacuum.

12. The method of use according to claim 10, wherein the method comprises at least one filling step, during which the pressurized tank is filled with the pressurized fluid from the pneumatic de-icing device.

13. The method of use according to claim 10, wherein the inflation step and the deflation step are repeated successively.
